(19) United States
(12) Patent Application Publication
(10) Pub. No.: US 2008/0152406 A1
(43) Pub. Date: Jun. 26, 2008

(54) ELECTROPHOTOGRAPHIC IMAGE FORMING APPARATUS AND PRINTING METHOD THEREOF

(75) Inventors: Won CHOE, Yongin-si (KR); So-won Sheen, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/766,130

(22) Filed: Jun. 21, 2007

(30) Foreign Application Priority Data
Dec. 26, 2006 (KR) 2006-134158

(51) Int. Cl. G03G 15/20; G03G 13/04

(52) U.S. Cl. 399/341; 430/48

(57) ABSTRACT

An electrophotographic image forming apparatus includes a color image forming portion to transfer a color toner to a printing medium to form a color toner image, a fusing unit to fuse the color toner image on the printing medium, a transparent image forming portion to transfer a transparent toner to the printing medium and being detachable, and a guide member to move into a first location in which the printing medium passing the color image forming portion is guided to the fusing unit and a second location in which the printing medium is guided to the transparent image forming portion.

### CROSS-REFERENCE TO RELATED APPLICATIONS

This application claims the benefit of Korean Patent Application No. 10-2006-0134158, filed on Dec. 26, 2006, in the Korean Intellectual Property Office, the disclosure of which incorporated herein in its entirety by reference.

### BACKGROUND OF THE INVENTION

1. Field of the Invention

The present general inventive concept relates to an image forming apparatus and a printing method thereof, and more particularly, to an electrophotographic image forming apparatus having a transparent toner and a printing method thereof.

2. Description of the Related Art

Electrophotographic image forming apparatuses form an electrostatic latent image by scanning light onto a photosensitive body charged to a uniform electric potential, develop the electrostatic latent image with a predetermined color of toner and then transfer and fuse the developed image to and on a printing medium, thereby printing a desired image. In general, four colors of toners, such as yellow (Y), magenta (M), cyan (C), and black (B), are used in electrophotographic color image forming apparatuses, and four developing units are used to develop the electrostatic latent image formed on the photosensitive body with these four colors of toners.

A toner is manufactured based on a plastic resin, and thus has some gloss. A portion of a printed image to which the toner is attached has some gloss, but a background region of the printed image to which the toner is not attached has no gloss. In addition, the higher coverage (the ratio of an area to which the toner is attached to the area of the printing medium) of the printed image, the higher the gloss. The gloss of the printed image affects the visual quality of the image. U.S. Patent Application No. 20060127134 discloses an image forming apparatus featuring a transparent image forming station to improve the gloss of a printed image by employing developing devices for developing electrostatic images with color toners and a developing device for developing an electrostatic image with a transparent toner.

### SUMMARY OF THE INVENTION

The present general inventive concept provides an electrophotographic image forming apparatus which covers a printing medium on which color toner images are printed, with a transparent toner and a printing method thereof.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing an electrophotographic image forming apparatus including a image forming portion to transfer a toner to a printing medium to form a toner image, a fusing unit to fuse the toner image on the printing medium, a transparent image forming portion to transfer a transparent toner to the printing medium and being detachable, and a guide member to change between a first location in which the printing medium passing the image forming portion is guided to the fusing unit and a second location in which the printing medium is guided to the transparent image forming portion.

The apparatus may further include a printing path on which the image forming portion is disposed, and a paper re-feeding path on which the printing medium passing the fusing unit is re-conveyed to the printing path.

The transparent image forming portion and at least part of the paper re-feeding path may constitute a replaceable optional unit.

The transparent image forming portion may include a donor roller having an outer circumference on which a transparent toner is attached, and a transparent toner transferring unit which is positioned to face the donor roller and to which a bias voltage to transfer the transparent toner attached to the donor roller to the printing medium is applied.

The transparent image forming portion may further include a supply roller which is rotated in contact with the donor roller and attaches the transparent toner to the donor roller.

The image forming portion can transfer color toners to the printing medium to form color images.

The image forming portion may include a plurality of photosensitive bodies, a plurality of the exposing units to form electrostatic latent images on the charged photosensitive bodies, and a plurality of developing units to supply different color toners to the electrostatic latent images of the plurality of photosensitive bodies to form a plurality of color toner images, whereby the image forming portion prints color images using a single pass technique.

The foregoing and/or other aspects and utilities of the present general inventive concept may also be achieved by providing a printing method of an electrophotographic image forming apparatus, the method including conveying a printing medium via a color printing path, transferring a color toner image to the printing medium using a color image forming portion and fusing the color toner image on a fusing unit, turning off the color image forming portion and re-feeding the printing medium on which the color toner image is formed to the color printing path, and transferring a transparent toner to the printing medium re-passing the color image forming portion using a transparent image forming portion and fusing the transparent toner on the fusing unit.

The foregoing and/or other aspects and utilities of the present general inventive concept may also be achieved by providing an electrophotographic image forming apparatus, including an image forming portion to form a toner image on a printing medium, a fusing unit to fuse a toner formed on the printing medium, a transparent toner forming portion to form a transparent toner on the printing medium, and a guide member to guide the printing medium alternatively to a first path toward the fusing unit to fix the toner image thereon and a second path toward the transparent image forming portion to transfer the transparent toner thereon.

The guide member switches between the first path and the second path.

The transparent image forming portion may include a donor roller having outer circumference to which a transparent toner is attached, and a transparent toner transferring unit which is positioned to face the donor roller and to which a bias voltage to transfer the transparent toner attached to the donor roller to the printing medium is applied.

The electrophotographic image forming apparatus may further include a third path in which the printing medium having the toner fixed thereto extends from the fusing unit back to the guide member after the printing medium has been guided along the first path to allow the guide member to guide the printing medium along the second path.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 illustrates a structure of a single pass color image forming apparatus which is a type of an electrophotographic image forming apparatus according to an embodiment of the present general inventive concept;

FIG. 2 illustrates an electric potential of the surface of an exposed photosensitive drum according to an embodiment of the present general inventive concept;

FIG. 3 illustrates the state where a transparent image forming portion is separated from the electrophotographic image forming apparatus illustrated in FIG. 1;

FIG. 4 illustrates a structure of a single pass color image forming apparatus which is a type of an electrophotographic image forming apparatus according to another embodiment of the present general inventive concept; and

FIG. 5 illustrates the state where a transparent image forming portion is separated from the electrophotographic image forming apparatus illustrated in FIG. 4.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

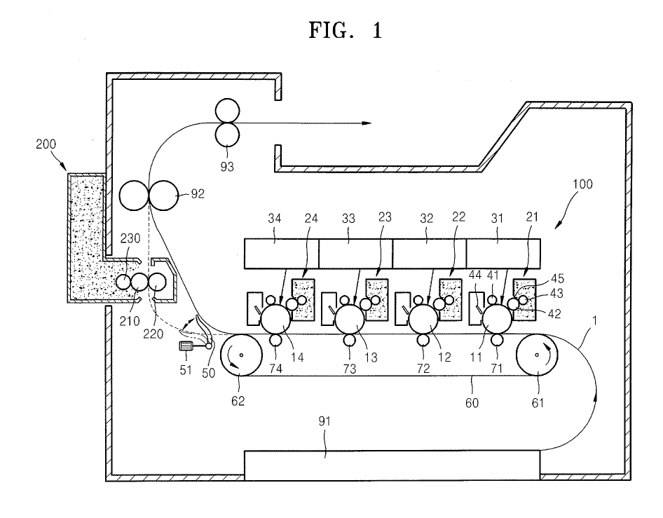

FIG. 1 illustrates a structure of an electrophotographic image forming apparatus according to an embodiment of the present general inventive concept. Referring to FIG. 1, the electrophotographic image forming apparatus according to the present embodiment includes a color image forming portion 100 and a transparent image forming portion 200. The color image forming portion 100 includes four photosensitive drums 11,12, 13, and 14, four exposing units 31, 32, 33, and 34, and four developing units 21, 22, 23, and 24, thereby printing color images using a single pass technique.

Each of the photosensitive drums 11,12, 13, and 14 is an example of a photosensitive drum on which an electrostatic latent image is to be formed, for example, an organic photosensitive body or an Amorphous silicon photosensitive body having a long life span. Each of the photosensitive drums 11, 12,13, and 14 corresponds to each of the developing units 21, 22, 23, and 24. Color toners such as black (B), magenta (M), cyan (C), and yellow (Y) are accommodated in the developing units 21, 22, 23, and 24.

Each of charging rollers 41 is an example of a charging unit to charge each of the photosensitive drums 11, 12, 13, and 14 to a uniform surface electric potential. The charging rollers 41 are in contact with the photosensitive drums 11, 12, 13, and 14, respectively. A charging bias voltage is applied to each of the charging rollers 41 and each of the charging rollers 41 charges the surface of each of the photosensitive drums 11, 12, 13, and 14 to a uniform electric potential.

Each of the exposing units 31, 32, 33, and 34 scans light modulated according to image information about black (B), magenta (M), cyan (C), and yellow (Y) colors, respectively, onto the photosensitive drums 11, 12, 13, and 14 and thereby forms electrostatic latent images. A laser scanning unit (LSU) that uses a laser diode as a light source, is usually used as each of the exposing units 31, 32, 33, and 34.

Each of the developing units 21, 22, 23, and 24 includes a developing roller 42 and a supply roller 43. The supply roller 43 attaches the toner accommodated in each of the developing units 21, 22, 23, and 24 to the developing roller 42. The developing units 21, 22, 23, and 24 may further include a regulating unit 45 which regulates the amount of the toner attached to the surface of the developing roller 42 to form a layer of toner having a uniform thickness. For example, the regulating unit 45 may be an elastic plate or roller which is elastically in contact with the developing roller 42. In addition, the developing units 21, 22, 23, and 24 may further include at least one carrying unit (not illustrated) which carries the toner accommodated in each of the developing units 21, 22, 23, and 24 into a region in which the developing roller 42 and the supply roller 43 face each other. When a contact developing technique is used, the developing rollers 42 are in contact with the photosensitive drums 11, 12, 13, and 14. A developing bias voltage, which is used to supply the color toners accommodated in the developing units 21, 22, 23, and 24 to electrostatic latent images of the photosensitive drums 11, 12, 13, and 14, is applied to each of the developing rollers 42. Due to the developing bias voltage, an electric potential difference between the developing rollers 42 and the electrostatic latent images is produced so that the toners are detached from the surface of the developing rollers 42 and are attached to the electrostatic latent images, and thus the electrostatic latent images are developed with the toners. When a non-contact developing technique is used, each of the developing rollers 42 is positioned to maintain a developing gap between each of the photosensitive drums 11, 12, 13, and 14, and for example, a bias voltage in which an AC current and a DC current are mixed, may be used as a developing bias voltage. The case where the contact developing technique is used will now be described.

In addition, a non-magnetic mono-component toner is used in the present embodiment, and the color toners are charged to a negative (-) polarity. A colorant to cause a change in color of a binder resin, internal additives such as a charge control agent (CCA), wax or the like, and external additives such as silica and titanium oxide (TiO₂) are added to the color toners. For example, charging amounts of the color toners are about −10 to −25 μC/g measured in suction type Faraday Gauge, and a layer of toner on a developing roller 42 is about 0.5 to 1 mg/cm².

A carrying belt 60 faces the photosensitive drums 11, 12, 13, and 14, is supported by support rollers 61 and 62, travels in a closed loop and carries the printing medium along a color printing path 1. Each of transfer rollers 71, 72, 73, and 74 is positioned to face each of the photosensitive drums 11, 12, 13, and 14 in the state where the carrying belt 60 and the printing medium are placed therebetween. A transfer bias voltage, which is used to transfer color toner images developed on the photosensitive drums 11, 12, 13, and 14 to the printing medium, is applied to each of the transfer rollers 71, 72, 73, and 74. For example, a conductive metal roller or a rubber roller in which a semi-conductive rubber having elasticity is put on a metal shaft may be used as each of the transfer rollers 71, 72, 73, and 74. A cleaning blade 44 is used to eliminate the toner remaining on the surface of each of the photosensitive drums 11, 12, 13, and 14 after a transfer operation. A fusing unit 92 fuses color toner images on the printing medium by applying heat and pressure to the printing medium.

The image forming apparatus according to an embodiment of the present general inventive concept is characterized by the detachable transparent image forming portion 200 used to transfer a transparent toner to the printing medium. The molecular weight of a binder resin of the transparent toner is less than the molecular weight of a binder resin of color toners so as to maintain a high gloss. In addition, the content of wax of the transparent toner is much less than the content of wax of the color toners. Referring to FIG. 1, the transparent image forming portion 200 includes a donor roller 210 and a transparent toner transferring unit 220 which faces the donor roller 210. Since the transparent image forming portion 200 transfers the transparent toner to all regions of the printing medium, an exposing unit is unnecessary. The donor roller 210 may be formed to have a shape in which a transparent toner cannot be permanently attached to the surface of the donor roller 210. For example, the donor roller 210 may be formed to have the same shape as that of the developing roller 42 of a mono-component developing unit. The transparent toner can be charged to a negative (−) or positive (+) polarity like in the color toners, and thus, can be retained on the surface of the donor roller 210 by a static electricity force. Accordingly, the outermost layer of the donor roller 210 may be formed of a semi-conductive material, for example. In addition, the transparent image forming portion 200 may further include a supply roller 230 which is rotated in contact with the donor roller 210 and friction-charges the transparent toner to allow the transparent toner to be attached to the donor roller 210. The transparent toner transferring unit 220 may have the shape of a roller that contacts the rear side of the printing medium, as illustrated in FIG. 1. A bias voltage having an opposite polarity as the charging polarity of the transparent toner is applied to the transparent toner transferring unit 220 so as to transfer the transparent toner from the donor roller 210 to the printing medium.

The image forming apparatus may further include a guide member 50. The guide member 50 is selectively moved into a first location in which the printing medium passing the color toner image forming portion 100 is guided to the fusing unit 92 and a second location in which the printing medium passing the color toner image forming portion 100 is guided to the transparent image forming portion 200, by using an actuator 51, such as, for example, a solenoid.

A printing method using the above-described structure according to an embodiment of the present general inventive concept will now be described.

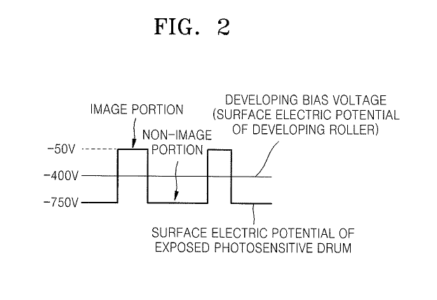

For example, the exposing unit 31 scans light onto the photosensitive drum 11 charged by the charging roller 41 to a uniform electric potential according to image information about black (B), and thereby forms an electrostatic latent image. For example, the surface electric potential of the photosensitive drum 11 charged by the charging roller 41 is approximately −750V, as illustrated in FIG. 2. The electric potential of an image portion onto which light is scanned by the exposing unit 31 is approximately −50V. A non-image portion onto which light is not scanned is maintained at the surface electric potential of the charged photosensitive drum 11. The average electric potential of the developing bias voltage to be applied to each developing roller 42 of the developing unit 21 is between the electric potential of the image portion and the electric potential of the non-image portion. In the present embodiment, the developing bias voltage having the average electric potential of about −400 V is applied to the developing roller 42. Since the black toner is charged to a negative (−) polarity, when the developing bias voltage is applied to the developing roller 42, the black toner accommodated in the developing unit 21 is attached to the image portion.

At a time in which a front end of a black toner image developed on the photosensitive drum 11 reaches a region in which the photosensitive drum 11 and the transfer roller 71 face each other, the printing medium supplied from the paper feeding cassette 91 reaches the region. A transfer bias voltage having an opposite polarity to the charging polarity of the black toner is applied to the transfer roller 71. As such, the black toner image developed on the photosensitive drum 11 is transferred to the printing medium.

The same operation as described above is performed by the photosensitive drums 12, 13, and 14, the exposing units 32, 33, and 34, and the developing units 22, 23, and 24, respectively, at time intervals each of which is given by the formula (distance between photosensitive drums)/(carrying speed of intermediate transfer belt), so as to meet color registration requirements.

Through the above-described operations, color toner images of black (B), magenta (M), cyan (C), and yellow (Y) are formed on the printing medium. The guide member 50 is positioned in the first location indicated by a solid line illustrated in FIG. 1. The printing medium to which the color toner images are transferred is guided to the fusing unit 92. When the printing medium passes the fusing unit 92, the color toner image is fused on the printing medium by heat and pressure. As such, color images are printed on the printing medium. The printing medium is exhausted by an exhaust roller 93.

In order to cover the transparent toner image on the color images, the exhausted printing medium is stacked on the paper feeding cassette 91 again and a paper re-feeding operation is performed via the color printing path 1. At this time, the color image forming portion 100 is in an off state. Thus, operations of developing and transferring color toners are not performed. The photosensitive drums 11, 12, 13, and 14 may be rotated together only when the conveying belt 60 travels along the closed loop. The guide member 50 is moved by the actuator 51 into the second location indicated by a dotted line illustrated in FIG. 1. The printing medium escaping from the conveying belt 60 is guided by the guiding member 50 to the transparent image forming portion 200. While the printing medium passes between the donor roller 210 and the transparent toner transferring unit 220, the transparent toner image on the surface of the donor roller 210 is transferred to the printing medium by the bias voltage applied to the transparent toner transferring unit 220. When the printing medium passes the fusing unit 92 again, the transparent toner image is fixed on the printing medium by heat and pressure.

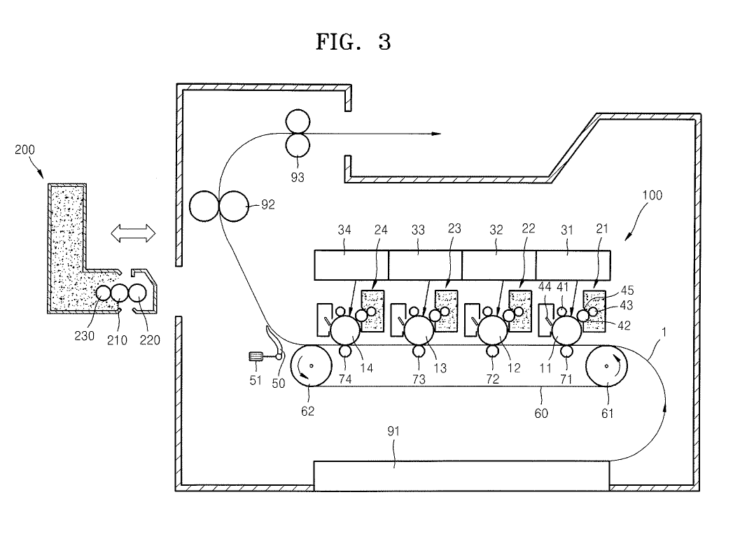

According to the above-described image forming apparatus and printing method, the gloss of the printed image can be improved. The transparent toner image may be covered on the color toner images according to user's selection. In addition, according to the present general inventive concept, since the transparent toner can be transferred to the printing medium using the transparent image forming portion 200 having the donor roller 210 and the transparent toner transferring unit 220, an exposing unit and a photosensitive body are not needed so that the structure of the image forming apparatus can be very simplified. In addition, as illustrated in FIG. 3, the transparent image forming portion 200 may be formed to have a structure in which the transparent image forming portion 200 can be attached to or detached from the image forming apparatus. Through the above structure, a user can install the transparent image forming portion 200 in the image forming apparatus by selectively adopting the same. In other words, when the transparent image forming portion 200 is desired to be used, the transparent image forming portion 200 can be attached to the image forming apparatus, and when the transparent image forming portion 200 is not required or desired to be used, the transparent image forming portion 200 can be detached from the image forming apparatus.

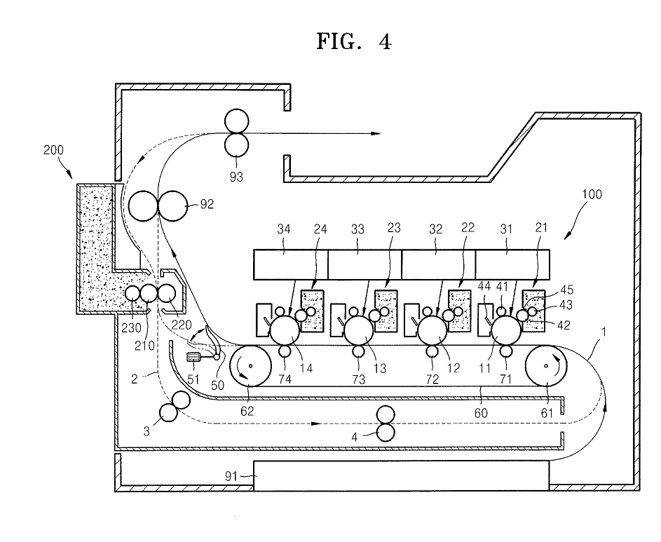

In the above-described embodiments, the printing medium on which the color toner images are printed is re-fed via the paper feeding cassette 91, and the transparent toner image is covered on the color toner images. As illustrated in FIG. 4, the image forming apparatus may further include a paper re-feeding path 2 to re-feed the printing medium passing the fusing unit 92 via the color printing path 1. The transparent image forming portion 200 may be positioned on the paper re-feeding path 2.

A printing method performed by using the above-described structure according to an embodiment of the present general inventive concept will now be described.

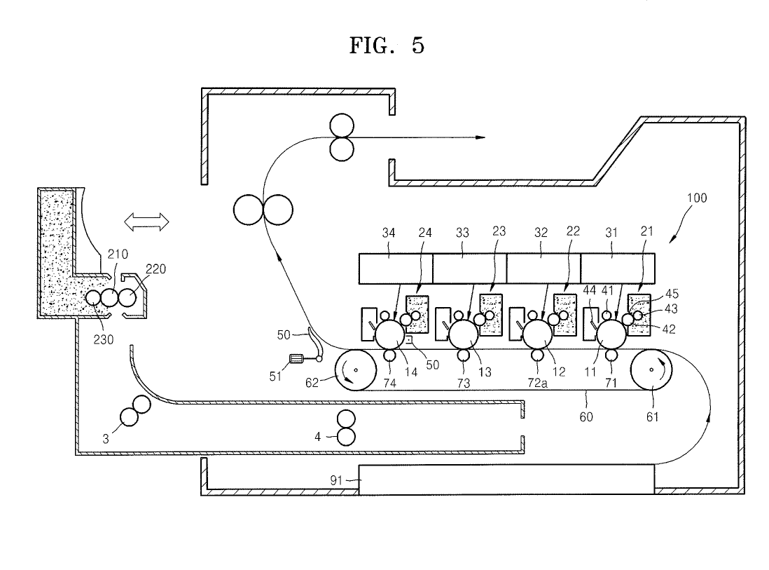

The exhaust roller 93 is rotated in a reverse direction before the ends of the printing medium to which the color toner images are transferred escape from the exhaust roller 93 after the printing medium passes the fusing unit 92. Then, the printing medium is conveyed along the paper re-feeding path 2. A plurality of paper feeding rollers 3 and 4 to convey the printing medium may be disposed on the paper re-feeding path 2. The printing medium is re-fed along the color printing path 1. At this time, the color image forming portion 100 is in an off state. Thus, operations of developing and transferring color toners are not performed. As pointed out above, only as the conveying belt 60 travels, the photosensitive drums 11, 12, 13, and 14 may be rotated together. The guide member 50 is moved by the actuator 51 into the second location indicated by a dotted line illustrated in FIG. 4. The printing medium escaping from the conveying belt 60 is guided by the guiding member 50 to the transparent image forming portion 200. While the printing medium passes between the donor roller 210 and the transparent toner transferring unit 220, the transparent toner image on the surface of the donor roller 210 is transferred to the printing medium by the bias voltage applied to the transparent toner transferring unit 220. When the printing medium passes the fusing unit 92 again, the transparent toner image is fixed on the printing medium by heat and pressure. As such, the gloss of the printed image can be improved. In addition, the transparent image forming portion 200 may be formed to have a structure in which the transparent image forming portion 200 can be attached to or detached from the image forming apparatus, as illustrated in FIG. 5. In addition, the entire paper re-feeding path 2 or part of the paper re-feeding path 2 may constitute an optional unit that can be attached to or detached from the image forming apparatus together with the transparent image forming portion 200. At this time, the paper feeding rollers 3 and 4 may be constituted with the transparent image forming portion 200 in a unitary body. Through the above structure, the user can install the transparent image forming portion 200 in the image forming apparatus by selectively adopting it.

The color image forming apparatus to print color images has been described in the above-described embodiments. However, the scope of the present general inventive concept is not limited to this description, but instead may also be applied to a single color image forming apparatus employing one developing unit to develop a single color toner.

As described above, in the electrophotographic image forming apparatus and the printing method according to various embodiments of the present general inventive concept, the transparent toner can be covered on the color toner images according to a user's selection. In addition, the transparent toner can be covered on the color toner images by using the transparent image forming portion having a very simple structure in which an exposing unit and a photosensitive body are not needed. By employing the transparent image forming portion that can be attached or detached to or from the image forming apparatus, the user can install the transparent image forming portion in the image forming apparatus by selectively adopting it.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electrophotographic image forming apparatus, comprising:
an image forming portion to transfer a toner to a printing medium to form a toner image;
a fusing unit to fuse the toner image on the printing medium;
a transparent image forming portion to transfer a transparent toner to the printing medium and being detachable; and
a guide member to move between a first location in which the printing medium passing the image forming portion is guided to the fusing unit and a second location in which the printing medium is guided to the transparent image forming portion.

2. The apparatus of claim 1, further comprising:
a printing path on which the image forming portion is disposed; and
a paper re-feeding path on which the printing medium passing the fusing unit is re-conveyed to the printing path.

3. The apparatus of claim 2, wherein the transparent image forming portion and at least part of the paper re-feeding path constitute a replaceable optional unit.

4. The apparatus of claim 1, wherein the transparent image forming portion comprises:
a donor roller having outer circumference to which a transparent toner is attached; and
a transparent toner transferring unit which is positioned to face the donor roller and to which a bias voltage to transfer the transparent toner attached to the donor roller to the printing medium is applied.

5. The apparatus of claim 4, wherein the transparent image forming portion further comprises:
a supply roller which is rotated in contact with the donor roller and attaches the transparent toner to the donor roller.

6. The apparatus of claim 1, wherein, the image forming portion transfers color toners to the printing medium to form color images.

7. The apparatus of claim 6, wherein the image forming portion comprises:
a plurality of photosensitive bodies;
a plurality of the exposing units to form electrostatic latent images on the charged photosensitive bodies; and
a plurality of developing units to supply different color toners to the electrostatic latent images of the plurality of photosensitive bodies to form a plurality of color toner images, whereby the image forming portion prints color images using a single pass technique.

8. A printing method of an electrophotographic image forming apparatus, the method comprising:
conveying a printing medium via a color printing path, transferring a color toner image to the printing medium using a color image forming portion and fusing the color toner image on a fusing unit;
turning off the color image forming portion and re-feeding the printing medium on which the color toner image is formed to the color printing path; and
transferring a transparent toner to the printing medium re-passing the color image forming portion using a transparent image forming portion and fusing the transparent toner on the fusing unit.

9. The printing method of claim 8, wherein the re-feeding the printing medium on which the color toner image is formed to the color printing path is performed along a second path and the re-passing the color image forming portion using a transparent image forming portion and fusing the transparent toner on the fusing unit is performed along a third path.

10. An electrophotographic image forming apparatus, comprising:
an image forming portion to form a toner image on a printing medium;
a fusing unit to fuse a toner formed on the printing medium;
a transparent toner forming portion to form a transparent toner on the printing medium; and
a guide member to guide the printing medium alternatively to a first path toward the fusing unit to fix the toner image thereon and a second path toward the transparent image forming portion to transfer the transparent toner thereon.

11. The electrophotographic image forming apparatus of claim 10, wherein the guide member switches between the first path and the second path.

12. The electrophotographic image forming apparatus of claim 10, wherein the transparent image forming portion is removably attachable and detachable along the second path.

13. The apparatus of claim 12, wherein the transparent image forming portion comprises:
a donor roller having outer circumference to which a transparent toner is attached; and
a transparent toner transferring unit which is positioned to face the donor roller and to which a bias voltage to transfer the transparent toner attached to the donor roller to the printing medium is applied.

14. The electrophotographic image forming apparatus of claim 13, wherein the second path extends between the doner roller and the transparent toner transferring unit when the transparent image forming portion is attached thereto.

15. The electrophotographic image forming apparatus of claim 11, further comprising:
a third path in which the printing medium having the toner fixed thereto extends from the fusing unit back to the guide member after the printing medium has been guided along the first path to allow the guide member to guide the printing medium along the second path.
